(19) United States
(12) Patent Application Publication
(10) Pub. No.: US 2013/0299134 A1
(43) Pub. Date: Nov. 14, 2013

(54) THERMAL EXPANSION JOINT AND HEAT EXCHANGER

(71) Applicant: Nicholas H. DESCHAMPS, Las Vegas, NV (US)

(72) Inventor: Nicholas H. DESCHAMPS, Las Vegas, NV (US)

(21) Appl. No.: 13/868,807

(22) Filed: Apr. 23, 2013

Related U.S. Application Data
(60) Provisional application No. 61/687,303, filed on Apr. 23, 2012.

(51) Int. Cl. F28F 9/00; F16L 51/02

(52) U.S. Cl. CPC F28F 9/00; F16L 51/02
USPC 165/81; 285/187; 285/47

(57) ABSTRACT

A heat exchanger is provided that includes an expansion joint that accommodates thermal expansion of an inner casing relative to an outer casing. The expansion joint is positioned between the inner casing and the outer casing and is shielded from high temperature fluid flows by a wall of the heat exchanger and by thermal insulation.

### BACKGROUND

This nonprovisional application claims the benefit of U.S. Provisional Application No. 61/510,830, titled “Thermal Expansion Joint for High Temperature Heat Exchanger,” filed Apr. 23, 2012, which is incorporated by reference herein in its entirety.

This disclosure is generally directed to a thermal expansion joint that can be used in high temperature environments. More specifically, this disclosure is directed to a high temperature heat exchanger that includes thermal expansion joints that are shielded from high temperature fluid streams.

Known heat exchangers can be of the plate or the tubular type. These heat exchangers may be used in a variety of applications, for example, in space heaters, industrial process heat exchange, refrigeration, air conditioning, power plants, thermal incineration preheater, and the like. A typical fluid-to-fluid plate heat exchanger includes multiple thin, slightly separated plates with large surface areas. A typical tubular heat exchanger includes a series of tubes including the fluid or fluid that would need to be heated or cooled.

In conventional heat exchangers, joints are needed to allow a hot inner casing to expand and contract in dimensions relative to a cooler outer casing, while still maintaining a barrier to fluid migration between the cooler fluid flow and hotter fluid flow.

### SUMMARY

Expansion joints are typically positioned at fluid inlets and outlets of heat exchangers. When the hot fluid enters and exits a conventional heat exchanger, it will contact the expansion joints, which are often unable to withstand extremely high temperatures and will deform or fail with prolonged exposure to heat. Such a failure involves significant maintenance because fixing or removing a failing expansion joint requires removing outer duct work and removing or hand-welding the failing joint. Further, a deformed or failed expansion joint may result in the outer casing being heated in an unwanted or unsafe manner.

Additionally, in the conventional tubular heat exchanger, slip joints between the outer and inner casing may be required near the hottest fluid flows, because expansion joints can fail at hot temperatures. However, in the event that one of the expansion joints on another inlet or outlet fails, hot fluid will pass through the slip joint and will travel to unwanted portions of the heat exchanger.

Disclosed herein is a heat exchanger that includes expansion joints arranged in such a manner so that an inner casing is still allowed to move with respect to an outer casing, but the expansion joints are not subject to the very high temperatures exhibited at or near the hottest fluid flow portions of the heat exchanger.

Embodiments of the heat exchanger of the present application may include an inner casing that houses a fluid path configured to accommodate a fluid flow; an outer casing separated from and surrounding at least a part of the inner casing; a fluid port that includes an opening corresponding to an inlet or outlet of the fluid path through the heat exchanger, the fluid port including a port wall; and an expansion joint provided proximate to the fluid port, the expansion joint being fixed to the inner casing and the outer casing, and having a bellows that is provided between the inner casing and the outer casing. The port wall may be provided between the fluid flow and the expansion joint and is spaced apart from the bellows, and the port wall may shield the expansion joint from the fluid flow.

In another aspect, a heat exchanger includes a first fluid port with a first port wall and a second fluid port with a second port wall, and an inner casing and an outer casing that surrounds at least a part of the inner casing. The inner casing houses a first fluid path that accommodates a first fluid flow that enters the heat exchanger at the first fluid port and houses a second fluid path that accommodates a second fluid flow that enters the heat exchanger at the second fluid port. The flow direction of the first fluid flow at the first fluid port can be substantially orthogonal to the second fluid flow at the second fluid port. The heat exchanger includes a first expansion joint provided proximate to the first fluid port, and the first expansion joint is positioned between the inner casing and the outer casing and accommodates thermal expansion of the inner casing in a first direction. The first expansion joint has a first bellows that is provided between the inner casing and the outer casing. The heat exchanger includes a second expansion joint provided proximate to the second fluid port, and the second expansion joint is positioned between the inner casing and the outer casing and accommodates thermal expansion of the inner casing in a second direction that is substantially orthogonal to the first direction. The second expansion joint likewise includes a second bellows that is provided between the inner casing and the outer casing. The first port wall is provided between the first fluid flow and the first expansion joint and is spaced apart from the first bellows, and the first port wall shields the first expansion joint from the first fluid flow. The second port wall is provided between the second fluid flow and the second expansion joint and is spaced apart from the second bellows, and the second port wall shields the second expansion joint from the second fluid flow.

In some aspects, the expansion joints described herein can be fixed to a first casing and a separate second casing, the first casing exhibiting temperature expansion relative to the second casing in a high temperature environment, the expansion joint comprising a bellows that is positioned between the first casing and the second casing and allows the first casing to expand when its temperature increases. A wall that is part of the first casing may be provided between the bellows and the high temperature environment, and the bellows can be spaced apart from the wall and maintained at a lower temperature than the wall.

### BRIEF DESCRIPTION OF THE DRAWINGS

Exemplary embodiments are described in detail below with reference to the accompanying drawings in which:

FIG. 1 is a perspective view of a conventional fluid heat exchanger with expansion joints and slip joints;

FIG. 2A is a cross-sectional view showing typical fluid flows in a conventional heat exchanger;

FIG. 2B is an expanded perspective view of conventional expansion joints arranged within the heat exchanger of FIG. 2A;

FIG. 3 is a perspective view illustrating an embodiment of a heat exchanger where the expansion joints are arranged in lower temperature regions;

FIG. 4A is an expanded perspective view illustrating expansion joints arranged respectively at a heat exchanger fluid inlet and outlet;

FIG. 4B is a plan view schematic diagram of the heat exchanger and expansion joints of FIG. 4A; and

FIG. 5 is a plan view schematic diagram of another embodiment of a heat exchanger and expansion joints.

### DETAILED DESCRIPTION OF THE EMBODIMENTS

Exemplary embodiments of the broad principles outlined herein are described with reference to the various drawings.

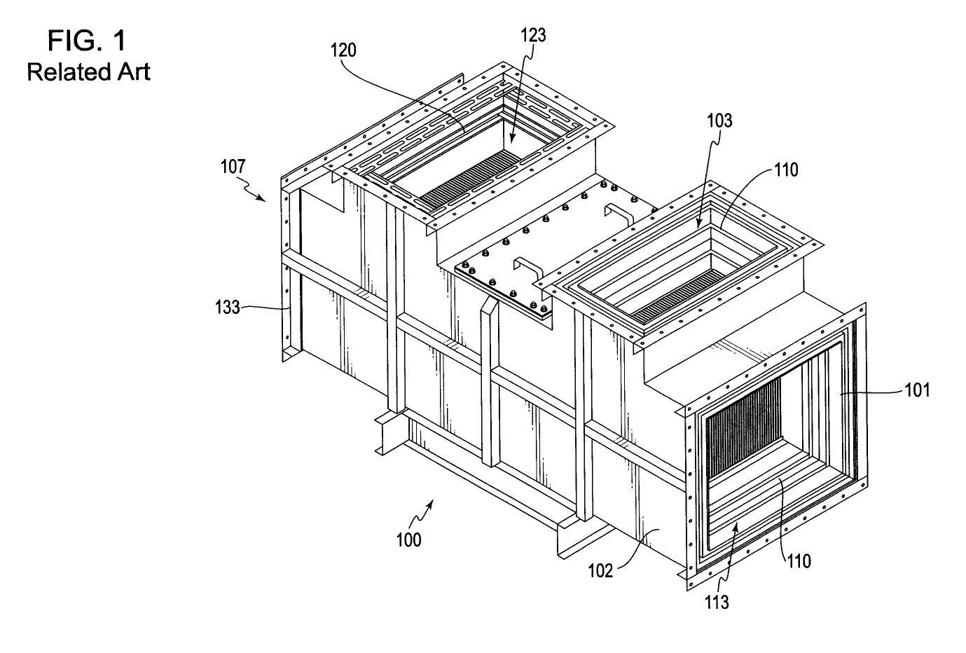

A conventional heat exchanger 100 is shown in FIG. 1 with a UI type flow pattern. The heat exchanger includes an inner casing 101 and an outer casing 102 and fluid ports 103, 107, 113, 123. The fluid ports each correspond to an inlet or outlet of a fluid stream of the heat exchanger. Expansion joints 110 are located at fluid ports 103, 113, and 107. Some of the ports can have a plurality of expansion joints allowing for axial and lateral expansion of inner casing 101. A slip joint 120 is provided at fluid port 123 and is positioned between the outer casing 101 and inner casing 102 to allow the inner casing to expand relative to the outer casing 101. Slip joints are used in high-temperature heat exchangers because the joints in these locations can be subjected to extreme heat, for example, temperatures of 1000° F. or higher, 1200° F. or higher, 1500° F. or higher, and up to 1700° F. or 1800° F. More generally, the temperatures of the fluid at the fluid port may be at a level that would cause material operating at this temperature to fail if exposed to certain stresses and temperature fluctuations. For example, referring to FIG. 1, the fluid port 123 can be connected to hot exhaust gas and used to heat up another process stream that is provided to fluid port 107. Expansion joints tend to deform upon being subjected to such heat, and thus, cannot reliably be used in these locations.

The slip joints 120 of FIG. 1 include a small gap of less than a half inch between the inner casing 101 and outer casing 102. If an expansion joint at another point becomes deformed or broken, fluid may then disadvantageously move through the gap in the slip joint and exit the chamber through the failed expansion joint. Further, deformation or breakage of an expansion joint may lead to mixing of fluid flows within the heat exchanger.

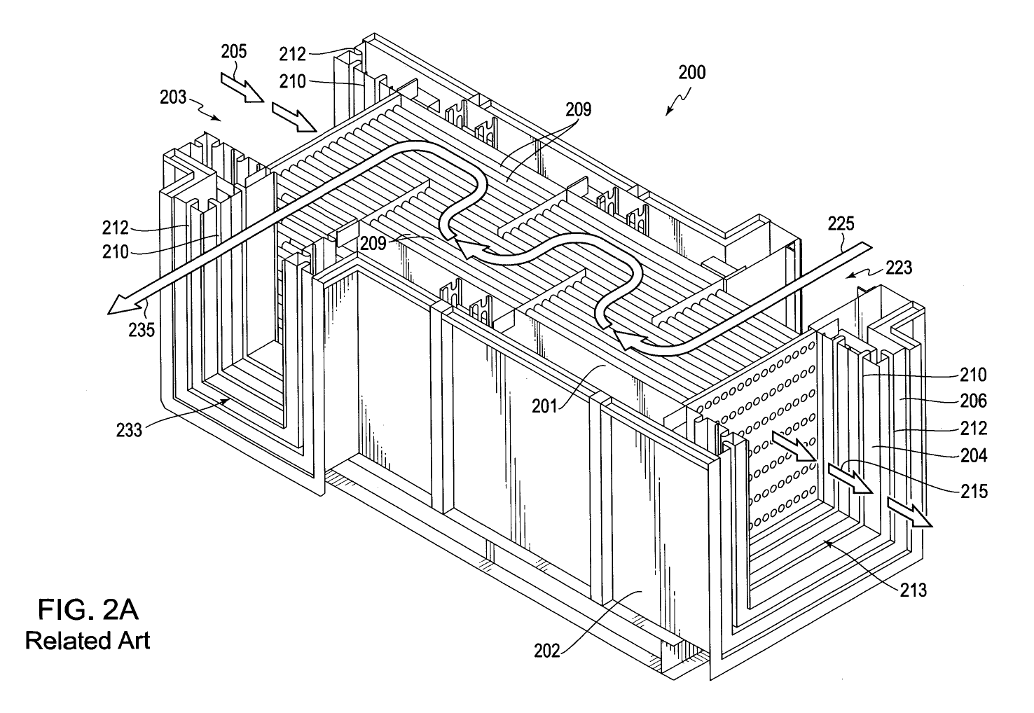

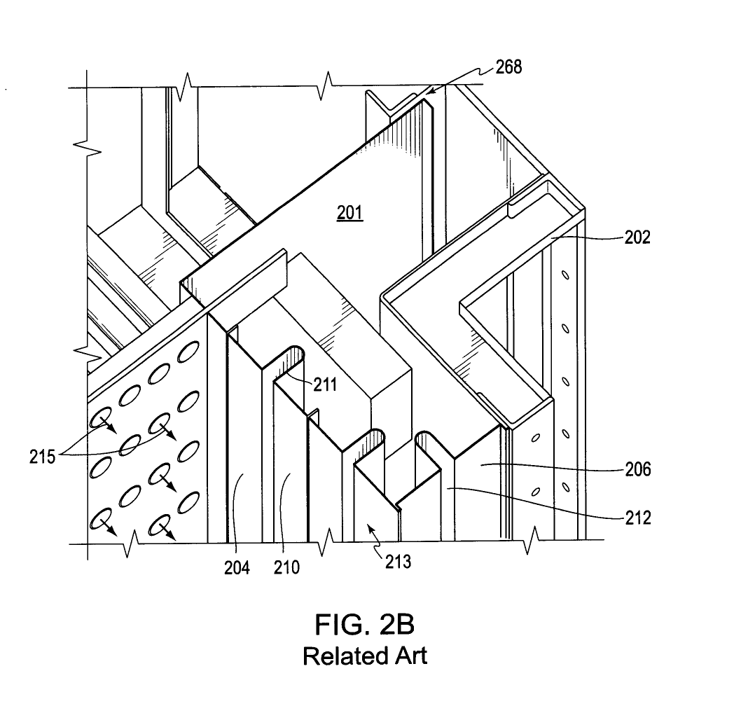

FIG. 2A illustrates a cross-section of a conventional heat exchanger 200 with ZI type of fluid flow. The heat exchanger comprises an inner casing 201 and outer casing 202. The heat exchanger processes a cooler fluid inlet flow 205 and a relatively warmer fluid outlet flow 215. The cooler fluid inlet flow 205 enters the heat exchanger 200 at fluid port 203 and travels along a fluid path through fluid channels 209 and exits at fluid port 213 as the relatively warmer fluid outlet flow 215. The heat exchanger also includes a hot fluid inlet flow 225 and a relatively cooler fluid outlet flow 235. The hot fluid inlet flow 225 enters the heat exchanger at fluid port 223 and travels along a fluid path outside of fluid channels 209 and exits the heat exchanger 200 at fluid port 233 as the relatively cooler fluid outlet flow 235. In general, the heat exchanger is constructed so that the two fluid flows do not mix.

To accommodate the expansion of the inner casing 201 with respect to outer casing 202, expansion joints are located at fluid ports 203, 213 and 233. As can be seen in the cross-sectional view, each of these fluid ports include expansion joints 210 that accommodate axial expansion of the inner casing and further include an expansion joints 212 that accommodate lateral expansion of the inner casing. Referring to FIG. 2B, which is an expanded view of a portion of heat exchanger 200, fluid port 223 typically accommodates very high temperature inlet gas and is provided only with a slip joint 268.

The expansion joints 210, 212 are positioned to be in direct contact with a fluid from fluid flow 215 at port 213. Indeed, the port wall 204 forms a part of expansion joint 210 and flange 206 forms a part of expansion joint 212. The fluid flow 215 can have very high temperatures, which is transferred directly to the expansion joints 210, 212 and causes them to operate at substantially the same temperature of fluid flow 215.

The yield stress of the expansion joint will deteriorate significantly once subjected to high temperatures over prolonged use, which causes joint failure. For example, Table 1 shows the yield strength, tensile strength and elongation percentage of 309S stainless steel at increasing temperatures. Yield strength decreases linearly with temperature until approximately 1500° F., at which time the yield strength begins to decrease exponentially. Significant decrease of the yield stress for an expansion joint requires repair or replacement, which can be costly and time-consuming.

TABLE 1

| | | | | | | | Elonga- |
|---|---|---|---|---|---|---|---|
| | Test Temperature | | Yield Strength | | Tensile Strength | | tion |
| | (° F.) | (° C.) | ksi | MPa | ksi | MPa | % |
| TYPE | 77 | 25 | 50.9 | 351 | 97.1 | 670 | 44.6 |
| 309S | 200 | 93 | 44.7 | 308 | 88.8 | 612 | 29.0 |
| | 400 | 204 | 37.4 | 258 | 81.7 | 563 | 34.5 |
| | 600 | 316 | 33.4 | 230 | 80.2 | 553 | 31.6 |
| | 800 | 427 | 29.6 | 204 | 77.1 | 531 | 32.1 |
| | 900 | 482 | 30.4 | 210 | 74.7 | 515 | 32.0 |
| | 1000 | 538 | 26.7 | 184 | 71.2 | 491 | 26.6 |
| | 1100 | 593 | 26.5 | 182 | 65.6 | 452 | 25.5 |
| | 1200 | 649 | 24.7 | 170 | 55.9 | 386 | 28.8 |
| | 1300 | 704 | 23.7 | 163 | 55.7 | 384 | — |
| | 1400 | 760 | 22.2 | 153 | 36.0 | 248 | 22.5 |
| | 1500 | 816 | 20.1 | 138 | 24.7 | 170 | 64.8 |
| | 1600 | 871 | 16.6 | 114 | 20.7 | 142 | 73.3 |
| | 1700 | 927 | 13.1 | 90 | 15.4 | 106 | 78.7 |
| | 1800 | 982 | 8.2 | 56 | 10.8 | 74 | — |
| | 1900 | 1038 | 4.6 | 32 | 6.6 | 46 | — |

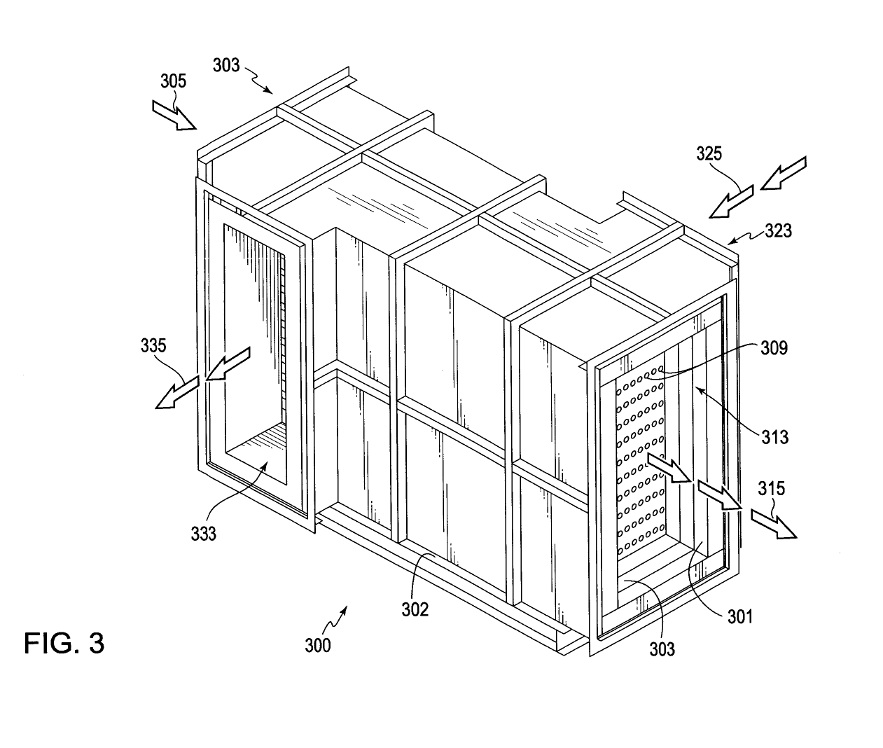

FIG. 3 illustrates a heat exchanger 300 according to one embodiment of the invention. Although the heat exchanger in FIG. 3 is shown as a ZI flow heat exchanger, any flow arrangement can be used, including ZZ, X, UU, UL, UI, and LL, for example. The heat exchanger typically includes two fluid streams but may include more than two fluid streams. The heat exchanger 300 may be used with a variety of applications, for example, exhaust process gas/air in industrial processes, air conditioners, humidifiers, and the like. The configuration of the separators between air streams in the heat exchanger can result in a plate-type or tubular heat exchanger, for example.

The heat exchanger 300 includes an outer casing 302. The outer casing may be separated from and may additionally surround at least a part of the inner casing 301 and preferably substantially the entire inner casing 301. The outer casing may be made of any suitable material, and is preferably made of 11 gauge carbon steel or similar. The inner casing 301 of the heat exchanger 300 can be made of any suitable material, and is preferably made of 12 gauge stainless steel, the alloy being somewhat dependent upon temperature of operation and corrosive materials present within the airstream.

The heat exchanger 300 processes a cooler fluid inlet flow 305 and a relatively warmer fluid outlet flow 315. The cooler fluid inlet flow 305 enters the heat exchanger 300 at fluid port 303 and travels along a straight fluid path (similar to the fluid path illustrated in FIG. 2B) through fluid channels 309 and exits at fluid port 313 as the relatively warmer fluid outlet flow 315. The heat exchanger also includes a hot fluid inlet flow 325 and a relatively cooler fluid outlet flow 335. The hot fluid inlet flow 325 enters the heat exchanger at fluid port 323 and travels along a fluid path (similar to the fluid path illustrated in FIG. 2B) outside of fluid channels 309 and exits the heat exchanger 300 at fluid port 333 as the relatively cooler fluid outlet flow 335. The heat exchanger is constructed so that the two fluid flows do not mix. In this case tubes are used that form fluid channels 309. However, plates or other structures can be used to separate the fluid flows and provide heat transfer between the fluid streams.

Expansion joints are not visible in the fluid ports of FIG. 3. Although the expansion joints are positioned proximate to the fluid ports, they are located between the inner and outer casing and are shielded from the fluid streams so that they are somewhat thermally insulated from the temperatures of the fluid streams. The expansion joints are not subjected to very high temperatures, and their structural and thermal properties are less likely to degrade or deform over time.

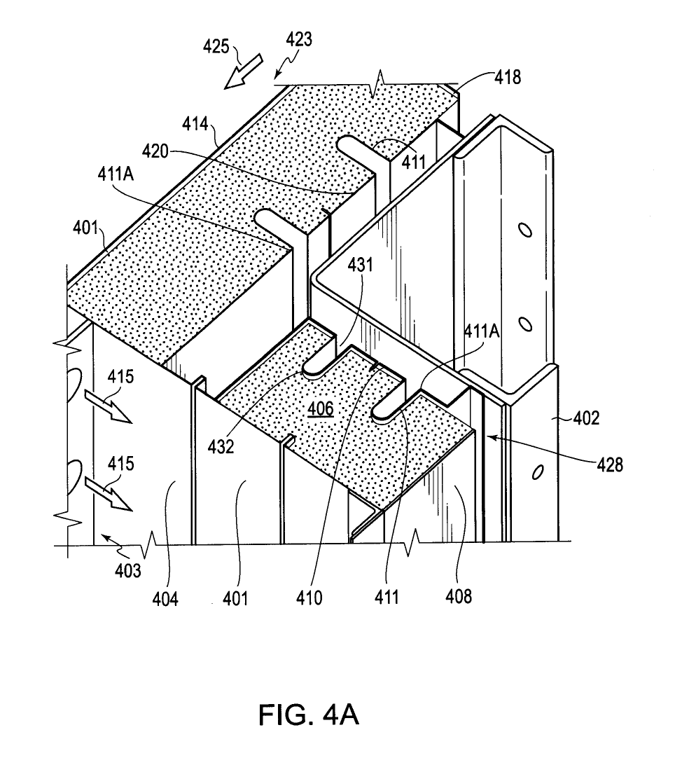

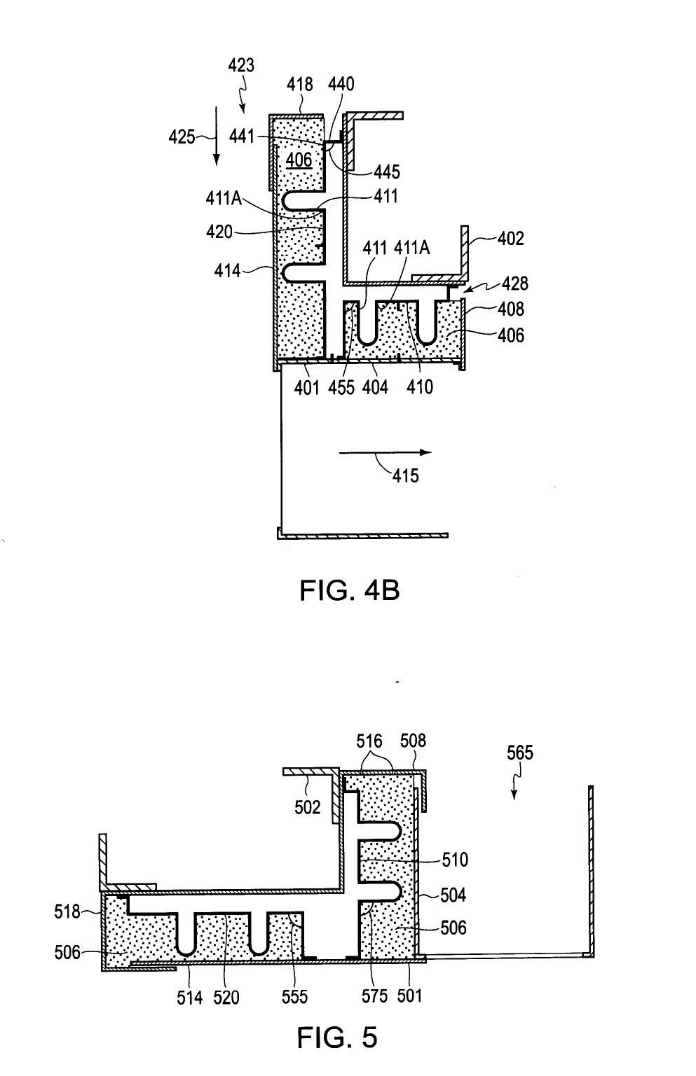

FIGS. 4A and 4B illustrate expansion joints according to an embodiment of the invention. FIG. 4A is an expanded view of a cross-section of a heat exchanger and FIG. 4B is a schematic diagram illustrating a cross-section of a portion of the heat exchanger (dimensions of FIG. 4B are not necessarily to scale). FIGS. 4A and 4B illustrate an expansion joint 410 positioned proximate to fluid port 403 and expansion joint 420 positioned proximate to fluid port 423. Although not illustrated in FIGS. 4A and 4B, each of the fluid ports can include several expansion joints, e.g., two or four expansion joints per fluid port where each joint is arranged proximate to a corresponding side of the fluid port.

The fluid port 403 may include a port wall 404 that is positioned between the fluid flow 415 and the expansion joint 410. Likewise, the fluid port 423 can include port wall 414 that is positioned between fluid flow 425 and expansion joint 420. The port walls can be part of the inner casing 401. In the embodiment depicted in FIG. 4A and 4B, the expansion joint 410 is fixed (e.g., by seam-welding) at one end to the port wall 404 that extends in a plane substantially parallel to fluid flow 415 and shields expansion joint 410 from the heat of fluid flow 415, i.e., the port wall 404 (together with any insulation) prevents substantial radiative and convective heat transfer to the expansion joint and reduces conductive heat transfer to the expansion joint. The expansion joint 410 is fixed at the other end to outer casing 402. Expansion joint 410 can accommodate axial expansion/contraction of the inner casing 401 (for example, expansion in the general direction of fluid flow 415). Expansion joint 420 is shielded from the heat of fluid flow 425 by port wall 414 that extends in a plane substantially parallel to fluid flow 425, but the expansion joint 420 is fixed at one end to port wall 404 and at the other end to outer casing 402. Expansion joint 420 can accommodate lateral expansion/contraction of the inner casing 401 (for example, expansion in the general direction of fluid flow 425). Connecting the expansion joints 410, 420 to the inner casing 401 and the outer casing 402 provides a seal therebetweeen so that inlet or outlet fluid streams do not penetrate the space between the inner and outer casing.

Fluid port 403 can include an end flange 408 that is fixed to the end of port wall 404 and extends in a direction substantially orthogonally to fluid flow 415. Because the expansion joint 410 provides a seal between the inner casing 401 and the outer casing 402, the end flange 408 does not need to be connected to the outer casing 402 and is preferably movable with respect to the outer casing 402, i.e., to accommodate lateral expansion of the inner casing 401. In the embodiment depicted in FIGS. 4A and 4B, the end flange 408 extends so that a gap 428 is provided between the end flange 408 and the outer casing 402. The gap forms a thermal break between the inner case and outer case and thereby inhibits heat from transferring to the outer case. Fluid port 423 includes end flange 418 that is arranged similarly.

Referring to FIG. 5, alternative arrangements of the expansion joints that allow for movement of the inner casing 501 with respect to the outer casing 502 can be used. For example, in this embodiment, the end flange 508 is fixed to the outer casing 502 but is not fixed to the port wall 504, so that relative movement due to lateral expansion of the inner casing 501 occurs between the end flange and the port wall. A similar configuration is used for end flange 518 with respect to port wall 514. Optionally, a plurality of slots 516 may be placed in the end flange 508 to reduce transverse heat that is transferred from the hot gas flow 565. The slots result in having the heat travel a much longer path to get from the inner wall to the outer wall and thus result in much less heat escaping to the outer wall. The final result is that the outer casing is much cooler as compared to a direct path for heat transfer. The slots can be preferably evenly spaced throughout the end plate 508, or the slots may be dispersed in an uneven manner.

Referring again to FIGS. 4A and 4B, the expansion joints 410, 420 can include one or more bellows 411. The bellows will flex when the internal casing 401 expands and contracts from changes in temperature. For example, in FIGS. 4A and 4B, bellows 411 will flex in a direction that is substantially parallel to the fluid flow to accommodate axial expansion of the inner casing 401. The bellows 411 may be formed as an elongate fold in the expansion joints 410, 420. The bellows may include an open end 431 and a closed end 432. The open end 431 can be proximate to the base 411a of the bellows, and the closed end 432 can be located opposite to the open end. The bellows may be of any suitable shape, for example, generally elliptical, oval-shaped, or square-shaped. The bellows 411 can be oriented so that the open end 431 faces away from port wall 404, 414 and can be oriented so that the open end 431 faces the outer casing 402.

Referring to expansion joint 410 as an example, the expansion joint can be positioned such that base 411 a of the bellows is closer to the outer casing 402 than it is to the inner casing 401 or port wall 404, e.g., preferably the distance from the base 411a to the port wall 404 is at least twice, and preferably at least three times, the distance from the base 411 a to the outer casing 402. In some embodiments, the expansion joint can be positioned so that the closed end 432 is positioned closer to the outer casing 402 than it is to the inner casing 401 or port wall 404.

Insulation 406 can be filled in between the outer casing and inner casing, particularly so that insulation exists between the bellows 411 of the expansion joints and the respective port walls that shield the expansion joint from the heat of the fluid flows. For simplicity, in FIGS. 4A, 4B and 5 the insulation is only shown between the bellows and the port walls. However, the insulation can be provided throughout the space between the inner casing 401/501 and the outer casing 402/502, including on the opposite side of the bellows. The insulation can be any suitable type of heat insulation material, including polymer foam, fiberglass, ceramic, natural materials, and may be provided in any form such as batting, foam, etc. Under this configuration, it is possible to maintain the bellows 411 at a temperature that is less than a third the temperature of the fluid stream, and more preferably less than half or two-thirds the temperature of the fluid stream. For example, if fluid flow 425 is 1500° F., the bellows 411 of expansion joint 420 can be maintained at a temperature of less than 1000° F., more preferably less than 750° F., more preferably less than 500° F., and even more preferably close to ambient temperature, e.g., in the range of 75° F. to 250° F. In contrast, the port wall 414 that shields (together with insulation 406) the expansion joint 420 from the fluid flow 425 will have a temperature that is very close to the fluid flow 425, e.g., at about 1500° F. in this example.

Because the bellows in the heat exchanger endure the load when the inner casing expands at high temperatures, they are the component that is most likely to fail after prolonged use. According to embodiments of the invention, the expansion joint is thus designed so that the closed end of the bellows is maintained at much lower operating temperatures than in conventional designs so that the bellows can maintain good strength properties over time. For example, referring to Table 1 above, if the closed end of the bellows is maintained in the range of 75° F. to 500° F., it will exhibit a significantly higher yield strength as compared to a bellows that is maintained at 1500° F. or higher.

As can be seen by the heat exchanger illustrated in FIGS. 4A and 4B, embodiments of the invention will also considerably reduce forces and resulting stresses on the bellows 411 because more parts of the expansion joint can contribute to the expansion process. Referring to FIG. 4B, the expansion joint 420 includes a connecting flange 440 that is fixed to the outer casing at one end and forms an angle 445 with base plane 441 that can grow larger or smaller as the inner case expands laterally, which relieves pressure on the bellows 411 of the expansion joint 420. The angle 445 can be within the range of about 30 to 150 degrees. Expansion joint 410 includes a similar intersection that forms angle 455 that can grow larger or smaller as the inner case expands axially, which likewise relieves pressure on the bellows 411 of expansion joint 410. The FIG. 5 embodiment is arranged similarly with expansion joints 510, 520 that form an intersection at an angle 555, 575, for example, that can become larger or smaller as the inner casing 501 expands and contracts. Insulation 506 may also be included, for example, between the inner casing 501 and outer casing 502.

Additionally, in embodiments of the invention, the total unit length and duct connection length can be reduced as compared to conventional heat exchangers.

In some embodiments of the invention, the expansion joints are not limited to heat exchanger devices and can be used to connect two casings of an apparatus where one casing exhibits thermal expansion relative to the other casing. In such an apparatus, the expansion joint can be configured similarly as discussed above to accommodate relative movement between the casings while shielding the bellows of the expansion joint from high temperatures.

Although the disclosed joints and heat exchangers have been described in conjunction with exemplary embodiments, these embodiments should be viewed as illustrative, not limiting. It should be understood that various modifications, substitutes, combinations or the like are possible within the spirit and scope of the disclosed devices.

What is claimed is:

1. A heat exchanger comprising:
an inner casing that houses a fluid path configured to accommodate a fluid flow;
an outer casing separated from and surrounding at least a part of the inner casing;
a fluid port that includes an opening corresponding to an inlet or outlet of the fluid path through the heat exchanger, the fluid port including a port wall; and
an expansion joint provided proximate to the fluid port, the expansion joint being fixed to the inner casing and the outer casing, and having a bellows that is provided between the inner casing and the outer casing,
wherein the port wall is provided between the fluid flow and the expansion joint and is spaced apart from the bellows, and the port wall shields the expansion joint from the fluid flow.

2. The heat exchanger according to claim 1, wherein the port wall is part of the inner casing.

3. The heat exchanger according to claim 1, wherein one end part of the expansion joint is fixed to the port wall and another end part of the expansion joint is fixed to the outer casing.

4. The heat exchanger according to claim 3, wherein the port wall is only connected to the outer casing by the expansion joint.

5. The heat exchanger according to claim 1, wherein the port wall extends in a plane that is substantially parallel to the direction of the fluid flow through the fluid port.

6. The heat exchanger according to claim 5, wherein the fluid port further includes an end flange that is provided on the outer end of the fluid port, the end flange being fixed to the port wall and extending in a plane that is substantially orthogonal to the port wall.

7. The heat exchanger according to claim 6, wherein the end flange is not fixed to the outer casing.

8. The heat exchanger according to claim 5, wherein the fluid port further includes an end flange that is fixed to the outer casing, the end flange extending in a plane that is substantially orthogonal to the port wall.

9. The heat exchanger according to claim 8, wherein the end flange is not fixed to the port wall.

10. The heat exchanger according to claim 1, further comprising insulation that is provided between the port wall and the bellows and insulates the bellows from heat in the fluid flow.

11. The heat exchanger according to claim 1, wherein the bellows is configured to accommodate thermal expansion and contraction in the expansion joint by flexing in a direction that is substantially parallel to the direction of fluid flow through the fluid port.

12. The heat exchanger according to claim 1, wherein the bellows is formed by an elongate fold in the expansion joint, and the bellows includes an open end proximate to its base and a closed end opposite the open end.

13. The heat exchanger according to claim 12, wherein the bellows is arranged so that the closed end faces the port wall and the open end faces away from the port wall.

14. The heat exchanger according to claim 12, wherein the bellows is arranged so that the open end faces the outer casing.

15. The heat exchanger according to claim 12, wherein the bellows is arranged so that its base is closer to the outer casing than it is to the port wall.

16. The heat exchanger according to claim 12, wherein the bellows is arranged so that its closed end is closer to the outer casing than it is to the port wall.

17. The heat exchanger according to claim 1, wherein the bellows has a length dimension extending in a direction substantially perpendicular to the direction of fluid flow through the fluid port.

18. The heat exchanger according to claim 1, wherein the temperature of the fluid flow at the fluid port is greater than 1,000° F.

19. The heat exchanger of claim 1, comprising at least two fluid ports that correspond to fluid inlets, and wherein each of the at least two fluid ports is connected to an expansion joint.

20. The heat exchanger of claim 1, wherein the fluid path comprises a plurality of fluid channels that extend along the fluid path.

21. The heat exchanger of claim 1, wherein the port wall and the expansion joint are made of sheet metal.

22. The heat exchanger of claim 6, wherein the end flange does not include bellows.

23. The heat exchanger of claim 8, wherein the end flange includes slots formed therein.

24. A heat exchanger comprising:
a first fluid port that includes a first port wall;
a second fluid port that includes a second port wall;
an inner casing that (i) houses a first fluid path configured to accommodate a first fluid flow that enters the heat exchanger at the first fluid port and (ii) houses a second fluid path configured to accommodate a second fluid flow that exits the heat exchanger at the second fluid port, the flow direction of the first fluid flow at the first fluid port being substantially orthogonal to the second fluid flow at the second fluid port;
an outer casing separated from and surrounding at least a part of the inner casing;
a first expansion joint provided proximate to the first fluid port, the first expansion joint positioned between the inner casing and the outer casing and accommodating thermal expansion of the inner casing in a first direction, the first expansion joint having a first bellows that is provided between the inner casing and the outer casing; and
a second expansion joint provided proximate to the second fluid port, the second expansion joint positioned between the inner casing and the outer casing and accommodating thermal expansion of the inner casing in a second direction that is substantially orthogonal to the first direction, the second expansion joint having a second bellows that is provided between the inner casing and the outer casing,
wherein the first port wall is provided between the first fluid flow and the first expansion joint and is spaced apart from the first bellows, and the first port wall shields the first expansion joint from the first fluid flow, and
the second port wall is provided between the second fluid flow and the second expansion joint and is spaced apart from the second bellows, and the second port wall shields the second expansion joint from the second fluid flow.

25. An expansion joint that is fixed to a first casing and a separate second casing, the first casing exhibiting temperature expansion relative to the second casing in a high temperature environment, the expansion joint comprising a bellows that is positioned between the first casing and the second casing and allows the first casing to expand when its temperature increases, wherein a wall that is part of the first casing is provided between the bellows and the high temperature environment, the bellows being spaced apart from the wall and maintained at a lower temperature than the wall.

26. The expansion joint of claim 25, further comprising insulation provided between the bellows and the wall.
